(19) United States
(12) Patent Application Publication
(10) Pub. No.: US 2025/0162162 A1
(43) Pub. Date: May 22, 2025

(54) OPERATING A FIREFIGHTING ROBOT BY REMOTELY DISPLAYING TOP-DOWN VIEWS

(71) Applicant: Howe & Howe Inc., Waterboro, ME (US)

(72) Inventors: Matthew Gregory Williams, Kennebunk, ME (US); Timothy Merlin Foley, Lyman, ME (US)

(21) Appl. No.: 18/948,840

(22) Filed: Nov. 15, 2024

Related U.S. Application Data
(60) Provisional application No. 63/599,798, filed on Nov. 16, 2023.

(51) Int. Cl. B25J 9/16; B25J 11/00; B25J 19/02

(52) U.S. Cl. CPC B25J 9/1697; B25J 11/002; B25J 19/023

(57) ABSTRACT

A technique for imaging surroundings of a firefighting robot includes receiving images from multiple cameras mounted to the firefighting robot and facing respective directions. The technique further includes combining the images from the cameras to construct a top-down view showing a central image of the robot and surroundings of the robot captured by the cameras. The technique still further includes transmitting the top-down view to a control device remote from the robot for display by the control device.

### CROSS-REFERENCE TO RELATED APPLICATIONS

This application claims the benefit of U.S. Provisional Application No. 63/599,798, filed Nov. 16, 2023, the contents and teachings of which are incorporated herein by reference in their entirety.

### BACKGROUND

Firefighting robots are specially adapted vehicles for spraying water on fires. Smaller than firetrucks, firefighting robots are maneuverable and able to aim water accurately at desired targets. For example, the Thermite robot available from Howe & Howe, Inc. of Waterboro, ME, is a remote-controlled, tracked vehicle with a nozzle (monitor) that can discharge 1,500 gallons or more of water per minute. The Thermite robot has the ability to withstand environments that are too hazardous for human personnel.

Some firefighting robots use cameras to capture live video of surroundings. For example, a firefighting robot may include a camera, and the vehicle may wirelessly transmit live video from the camera to a remote-control device located some distance away, such as at a location not subject to immediate danger. The remote-control device may display the live video on a screen, which a human operator may observe to gain situational awareness of the vehicle's environment, to assist in maneuvering the vehicle around obstacles, and to aim the water nozzle in the direction of fires.

### SUMMARY

Unfortunately, conventional camera views sent from a firefighting robot are often insufficient for enabling an operator to achieve adequate situational awareness of an entire area around the robot. Even if the robot includes multiple cameras, available views are still limited, and remote operators can easily become confused about which direction they are viewing at a given time. Such confusion and lack of visibility can cause accidents that lead to damage to the robot or surrounding structures and can render the robot less capable of achieving its firefighting mission than might otherwise be possible. What is needed, therefore, is a way of improving the display of an environment around a firefighting robot so that the robot can be employed more effectively.

To address the above need at least in part, an improved technique for visualizing an environment around a firefighting robot includes receiving images from cameras mounted to the firefighting robot and facing in respective directions, synthesizing a top-down view of the robot and its immediate surroundings based on the received images, and transmitting the top-down view for display on a control device.

Advantageously, an operator of the control device can observe the environment all around the robot in a single view presented in a consistent manner, e.g., with the robot normally facing the same direction on a screen of the control device. The consistent view avoids operator confusion. Obstacles in the environment can be readily visualized, avoiding accidents and damage. In addition, the operator can more easily maneuver the robot through tight spaces, helping the operator to move the robot quickly and efficiently, such that the robot is able to achieve its mission more effectively.

Certain embodiments are directed to a method of imaging surroundings of a firefighting robot. The method includes receiving images from multiple cameras mounted to the firefighting robot and facing respective directions. The method further includes combining the images from the cameras to construct a top-down view showing a central image of the robot and surroundings of the robot captured by the cameras. The method still further includes transmitting the top-down view to a control device remote from the robot for display by the control device.

Other embodiments are directed to a firefighting robot. The robot includes a robot body. The robot further includes multiple cameras mounted to the robot body and facing respective directions relative to the robot body. The robot still further includes control circuitry operatively coupled with the cameras. The control circuitry is constructed and arranged to combine images from the cameras to construct a top-down view showing a central image of the robot and surroundings of the robot captured by the cameras. The robot still further includes wireless communication circuitry constructed and arranged to transmit the top-down view for display remotely from the robot.

Still other embodiments are directed to a firefighting system. The system includes a firefighting robot, such as the firefighting robot described above. The system further includes a remote-control device. The remote-control device includes a wireless interface constructed and arranged to receive the top-down view from the robot. The remote-control device further includes a screen constructed and arranged to display the top-down view.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is an upper front-right perspective view of a first example firefighting robot with which certain embodiments may be practiced.

FIG. 2 is an upper back-right perspective of the first firefighting robot of FIG. 1.

FIG. 3 is an upper front-right perspective view of a second example firefighting robot with which certain embodiments may be practiced.

FIG. 4 is an upper back-right perspective of the second firefighting robot of FIG. 3.

FIG. 5 is an upper front-right perspective view of a third example firefighting robot with which certain embodiments may be practiced.

FIG. 6 is an upper back-right perspective of the third firefighting robot of FIG. 5.

FIG. 7 is a top view of an example control device with which certain embodiments may be practiced.

FIG. 8 is an example screenshot of an example display showing a top-down view of a firefighting robot.

FIG. 9 is a flowchart of an example procedure in which a firefighting robot provides top-down and individual camera views for display remotely from the firefighting robot.

FIG. 10 is a flowchart of an example procedure in which a control device requests and displays top-down and individual camera views from a firefighting robot.

FIG. 11 is a flowchart of an example procedure in which a firefighting robot aligns respective images from cameras mounted to surfaces of the firefighting robot.

FIG. 12 is a flowchart of an example procedure for imaging surroundings of a firefighting robot.

### DETAILED DESCRIPTION

Embodiments of the improved technique will now be described. One should appreciate that such embodiments are provided by way of example to illustrate certain features and principles but are not intended to be limiting.

An improved technique for visualizing an environment around a firefighting robot includes receiving images from cameras mounted to the firefighting robot and facing in respective directions, synthesizing a top-down view of the robot and the immediate surroundings of the robot based on the received images, and transmitting the top-down view for display on a control device.

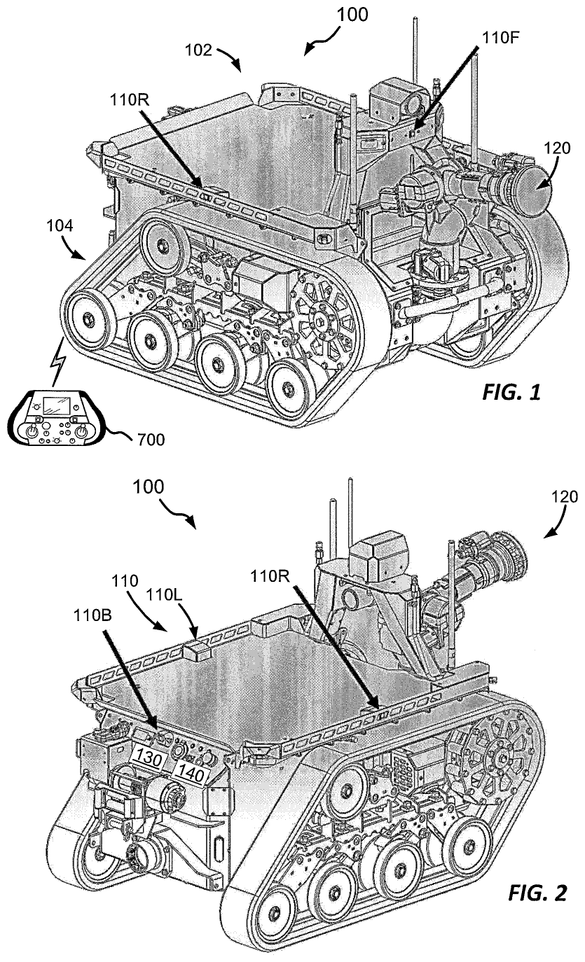

FIGS. 1 and 2 show an example firefighting robot 100 in accordance with certain embodiments. Here, the robot 100 includes a vehicle body 102, tracks 104, multiple cameras 110, a nozzle (monitor) 120, a processing device 130, and a wireless communication circuitry 140. FIG. 1 further shows a control device 700 for operating the robot 100.

The body 102 includes a chassis that houses various equipment for propelling and operating the vehicle, such as batteries and electric motors for use with electrical-drive systems, and/or a fuel tank and liquid-fuel engine for use with internal-combustion drive systems. The body 102 also houses computers, control systems, and the like, such as the processing device 130 and the wireless communication circuitry 140. The motors and/or engine are configured to drive the tracks 104, e.g., via one or more gearboxes within the body 102. Although tracks 104 are shown, the robot 100 may be additionally or alternatively equipped with other ground-engaging members, such as wheels, skis, and so forth.

The cameras 110 are mounted on the body 102 and face respective directions relative to the robot 100. The cameras 110 may include, for example, a front camera 110F that faces in a forward direction relative to the robot 100, a rear camera 110B that faces in a rearward direction relative to the robot 100, a left camera 110L that faces in a leftward direction relative to the robot 100, and a right camera 110R that faces in a rightward direction relative to the robot 100.

In some examples, greater than four cameras may be included for providing additional views and/or for redundancy. Alternatively, fewer than four cameras may be provided in some embodiments, e.g., for covering less than a 360-degree view.

The cameras 110 are operatively coupled with control circuitry of the processing device 130 for providing video images to the processing device 130. For example, the cameras 110 may be hardwired to or wirelessly coupled with the processing device 130.

The cameras 110 have respective fields of view. In some embodiments, the field of view of each camera overlaps at least partially with the fields of view of two other cameras. For example, the field of view of the front camera 110F partially overlaps with respective fields of view of the left camera 110L and the right camera 110R. In some embodiments, one or more of the fields of view exceed 90 degrees. For example, the cameras may employ fish-eye lenses and the fields of view may be greater than 180 degrees. There is no requirement that the cameras all have the same field of view, however.

Preferably, the cameras 110 are visible-light cameras. However, the cameras 110 may be other types of camera, such as infrared cameras.

The nozzle 120 is constructed and arranged to discharge firefighting fluid, e.g., water, foam, or a combination thereof. For example, a coupling at the rear of the vehicle 100 may receive firefighting fluid from a hose connected to a hydrant or firetruck. Piping within the robot 100 conveys the fluid to the nozzle 120, which can be aimed under remote control in both altitude and azimuth, for emitting the fluid in desired directions.

In some examples, the processing device 130 includes an electronic control unit (ECU) of the robot 100. The processing device 130 (e.g., the ECU) is constructed and arranged to combine images from the cameras 110 into a top-down view showing a central image of the robot 100 and surroundings of the robot 100 captured by the cameras 110 and displayed around the central image. For example, the ECU may run software for stitching together and geometrically adjusting camera views to synthesize the top-down view.

The central image 802 is a representation of the robot 100, such as a photograph, drawing, or animation. Preferably, the central image 802 is oriented consistently, e.g., with the front of the robot always facing the same direction (e.g., to the left in FIG. 8). The consistent display helps to avoid operator confusion.

The processing device 130 is further configured to switch between the top-down view and individual respective views from the cameras 110, e.g., in response to commands received from the control device 700 located remotely from the robot 100. For example, the processing device 130 may provide the top-down view and then switch to providing an individual camera view from one of the cameras 110.

The wireless communication circuitry 140 is configured to communicate with the control device 700. Along these lines, the wireless communication circuitry 140 is configured to transmit the top-down view and the individual camera views to the control device 700 for display remotely from the robot 100. For example, the wireless communication circuitry 140 may transmit the views one-at-a-time or may transmit multiple views simultaneously. The wireless communication circuitry 140 is further configured to receive various commands from the control device 700, e.g., to switch between the multiple views, to reposition the nozzle 120, to drive the robot 100, and so forth.

Preferably, the wireless communication circuitry 140 is configured to communicate over radio frequencies, such as Bluetooth, Bluetooth Low Energy, Wi-Fi, or some other radio-frequency protocol.

During operation, the multiple cameras 110 provide video images to the processing device 130. The processing device 130 combines the video images into a top-down view that shows a central image of the robot 100 and surroundings of the robot 100. Further, the processing device 130 provides the top-down view to the wireless communication circuitry 140, which transmits the top-down view to the control device 700 for display by the control device 700.

Advantageously, an operator of the control device is able to see the top-down view and thereby to gain situational awareness of the environment surrounding the robot 100. In this manner, obstacles in the environment can be readily visualized, avoiding accidents and damage. In addition, the operator can more easily maneuver the robot 100 through tight spaces, helping the operator to move the robot 100 quickly and efficiently.

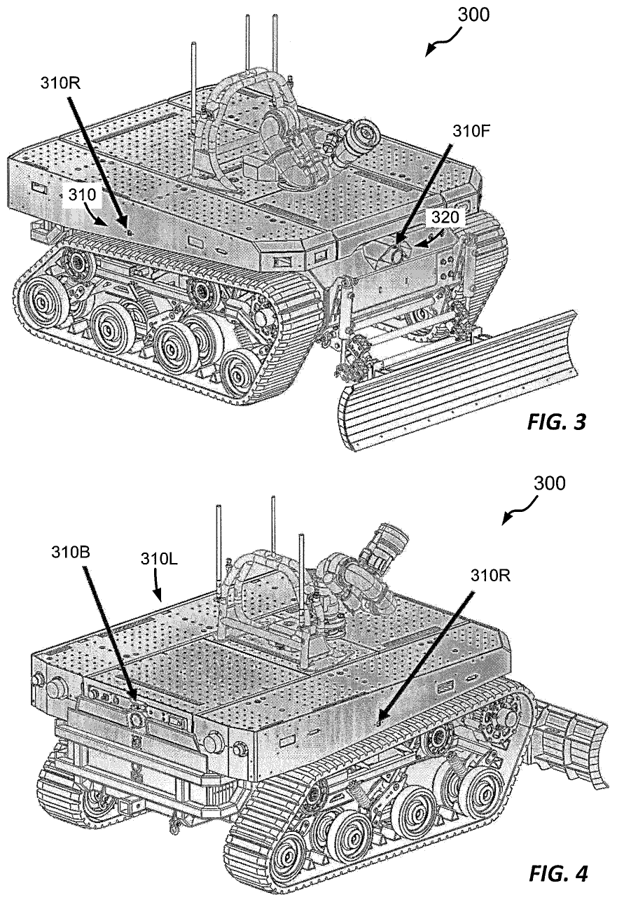

FIGS. 3 and 4 show a second firefighting robot 300, which provides similar functionality as the robot 100 discussed above in regards to FIGS. 1 and 2. Along these lines, the robot 300 includes cameras 310F, 310B, 310R, and 310L (collectively, cameras 310) facing respective directions relative to the robot 300 and a nozzle mounted to a top deck of the robot 300. Additionally, a plow attachment is provided on the front of the robot 300.

In some examples, the robot 300 further includes a brow 320 or other protrusion over one or more of the cameras 310 for protecting such cameras 310 against impacts and to prevent water from dripping onto the camera lenses. Preferably, each such brow 320 is composed of metal, such as stainless steel, or some other impact and rust-resistant material. In some embodiments, the brows 320 extend above respective cameras 310 while leaving the sides and bottom unobstructed. In this manner, the cameras 310 provide clear views side-to-side and downward, enabling the cameras 310 to show the surroundings of the robot 300 and to provide an accurate top-down view.

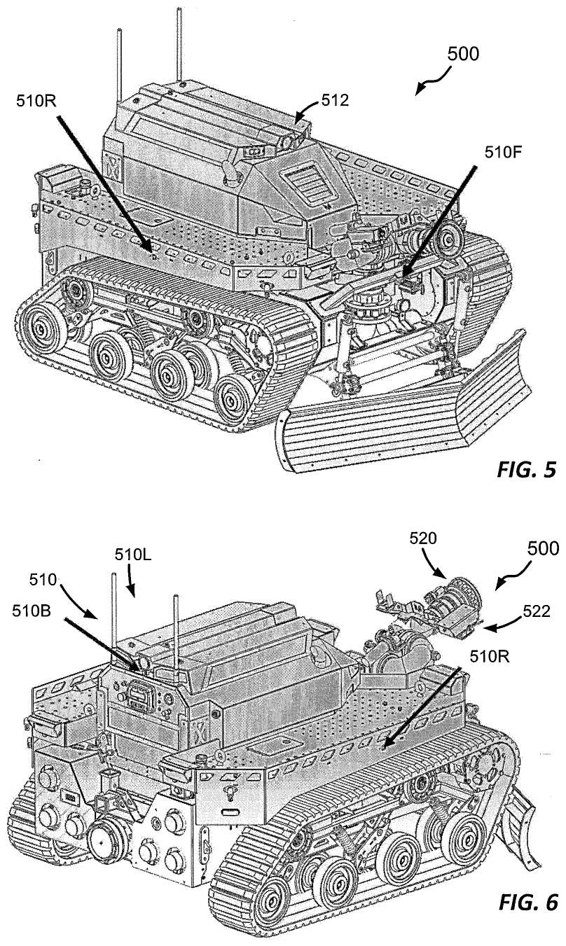

FIGS. 5 and 6 show a third firefighting robot 500, which may provide similar functionality as the robots 100 and 300 discussed above in regards to FIGS. 1 through 4. Along these lines, cameras 510F, 510B, 510R, and 510L (collectively, cameras 510) are mounted on various surfaces of the robot 500. In this arrangement, both a nozzle 520 and a plow are mounted to the front of the robot 500. Further, an additional camera 512 is similarly mounted to an upper portion of the robot 500, and a nozzle camera 522 is mounted to the nozzle 520.

As best shown in FIG. 6, the cameras 510 may be mounted at different heights from each other, e.g., camera 510R is mounted at a first height relative to the robot 500, while camera 510B is mounted at a second height greater than the first height. Images from these cameras 510 may be combined to construct a top-down view, e.g., as similarly described above in regards to the robot 100 (FIGS. 1 and 2).

In an example, the additional camera 512 faces the same direction as one or more of the cameras 510, such as camera 510F. Further, the additional camera 512 and the camera 510F are mounted at different heights relative to the robot 500. In this manner, the additional camera 512 provides a different perspective of the forward surroundings of the robot 500, compared to the camera 510F.

Further, the nozzle camera 522 is configured to provide video images from the perspective of the nozzle 520, e.g., to show where the nozzle 520 is pointing. The cameras 510, the additional camera 512, and the nozzle camera 522 may be operatively coupled with a processing device (not shown) for providing video images to the processing device. The processing device may be similar to the processing device 130 (FIG. 1).

Different combinations of images from the cameras may be combined to construct respective top-down views. For example, the control device 700 may be operated in a first manner to direct the processing device 130 to generate the top-down view using cameras 510F, 510R, 510B, and 510L. The control device 700 may also be operated in a second manner to direct the processing device 130 to generate a different top-down view using cameras 512, 510R, 510B, and 510L. As the camera 512 is mounted higher than the camera 510F, the resulting top-down views may show the surroundings of the robot 500 from different perspectives. Advantageously, providing multiple top-down views from different perspectives enables an operator to obtain greater awareness of the surroundings of the robot 500.

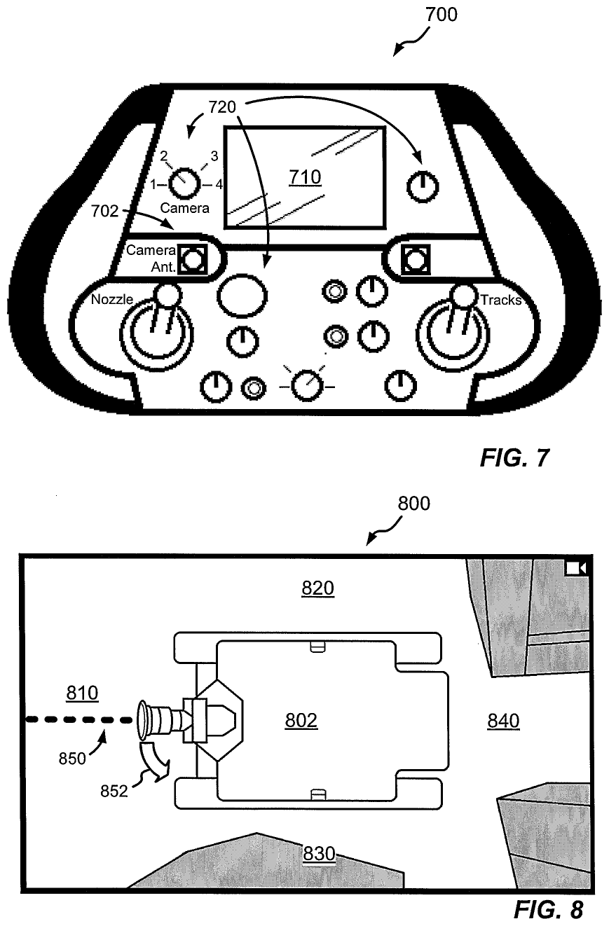

FIG. 7 shows additional details of the example control device 700 for controlling the firefighting robot 100, 300, and/or 500 (FIGS. 1 through 6). The control device 700 may be provided as a belly-pack controller including a wireless interface 702, a display screen 710, and user-input controls 720. The control device 700 further includes an internal battery or other power source (not shown), e.g., for enabling operation of the control device 700 away from the robot 100 and away from any electrical outlets.

The wireless interface 702 includes a transceiver for wireless communication with the robot 100, such as by using any of the wireless communication protocols described above. The wireless interface 702 is configured to receive video signals from the robot 100. The video signals may include, for example, a top-down view and individual respective views of the cameras. The wireless interface 702 is further configured to send commands to the robot 100, e.g., commands generated in response to operation of the user-input controls 720.

The display screen 710 is configured to display the video signals, e.g., to an operator of the control device 700.

The user-input controls 720 are configured to control various aspects of the robot 100. For example, as shown, the user-input controls 720 includes a rotatable toggle control to switch images rendered on the display screen 710 between a top-down view and one or more individual views from the cameras 110. The user-input controls 720 may further include other controls, such as a joystick for operating (driving) the tracks 104, a joystick for repositioning the nozzle 120, controls for discharging firefighting fluid from the nozzle 120, and so forth.

During operation, an operator may provide user input to the control device 700 for operating of the robot 100. In response to the user input, the control device 700 transmits commands to the robot 100 via the wireless interface 702. The control device 700 further receives and displays one or more views received from the robot 100, e.g., a top-down view or individual camera views from the cameras 110. In this manner, the operator may gain situational awareness of the surroundings of the robot 100 and operate the robot 100 accordingly.

FIG. 8 shows an example screenshot 800 from the display screen 710 of the control device 700 (FIG. 7). In the screenshot 800, a top-down view shows a central image 802 of the firefighting robot 100 (FIG. 1) and the surroundings of the robot 100. The top-down view further shows various display elements including directional indicators 850, 852.

In the depicted example, the top-down view is a 360-degree view all the way around the robot 100. That is, views of the surroundings of the robot 100 are placed relative to the central image 802 of the robot 100, such that objects in front of the robot 100 appear as images 810 displayed in front of the central image 802, objects to the right of the robot 100 appear as images 820 displayed to the right of the central image 802, and objects to the left of the robot 100 appear as images 830 displayed to the left of the central image, and objects behind the robot 100 appear as images 840 displayed behind the central image 802.

The directional indicator 850 shows a direction in which the nozzle 120 of the robot 100 is aimed. It should be understood that the direction in which the nozzle 120 is aimed may be represented in a variety of ways, e.g., by rotating the depiction of nozzle 120 in the central image 102. The example shown is merely illustrative.

Similarly, the directional indicator 852 shows a movement direction of the nozzle 120 as the nozzle is repositioned. The directional indicator 852 may represent changes in azimuth, or changes in both azimuth and altitude.

In some examples, the processing device 130 (FIG. 2) of the robot 100 dynamically adjusts the central image 802 of the robot 100 in the top-down view to reflect a condition of the robot 100. For example, in response to the nozzle 120 of the robot 100 being repositioned to aim in a particular direction, the processing device 130 updates the directional indicator 852 to reflect the movement of the nozzle 120. The processing device 130 also updates the directional indicator 850 to reflect the new direction in which the nozzle 120 is pointing. Advantageously, dynamically adjusting the central image 802 enables an operator to quickly and easily determine the position of the nozzle 120.

In some embodiments, the central image of the robot 100 remains in a static orientation on the display 710. That is, as the robot 100 is driven, the central image 802 remains stationary on the display 710 as views of the surroundings of the robot 100 change. In this manner, an operator may readily visualize obstacles in the surroundings of the robot 100 without becoming confused as to the relative positions of the obstacles relative to the robot 100.

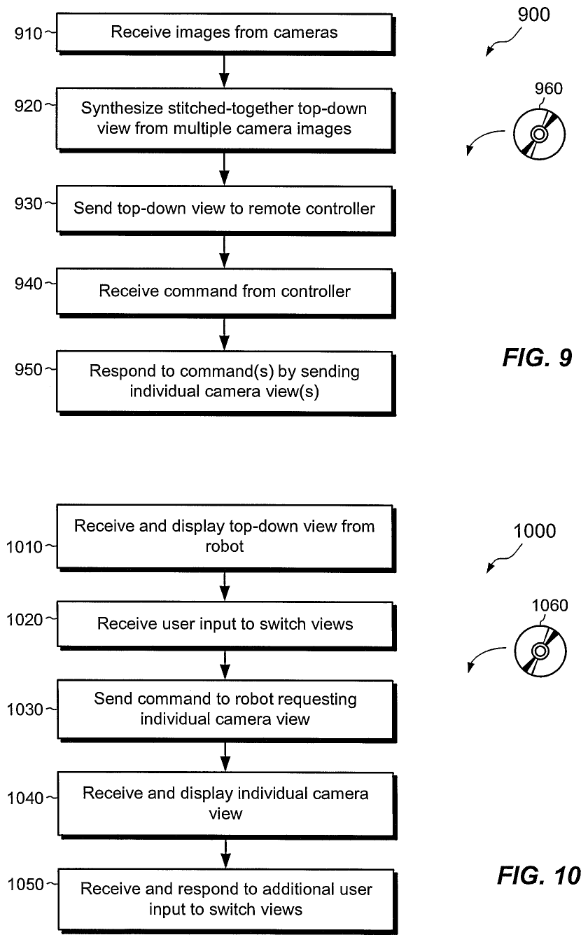

FIG. 9 shows a flowchart of an example procedure 900 in which the processing device 130 (FIG. 2) provides top-down and individual camera views to the control device 700 (FIG. 7) for display remotely from the firefighting robot 100.

At 910, the processing device 130 receives images from the cameras 110 mounted to respective surfaces of the robot 100.

At 920, the processing device 130 combines the images from the cameras 110 to construct a top-down view, which shows a central image of the robot 100 and the surroundings of the robot 100.

At 930, the processing device 130 provides the top-down view to the wireless communication circuitry 140, which transmits the top-down view to the control device 700.

At 940, the processing device 130 receives a command that directs the processing device 130 to provide an individual view from one of the cameras 110. The processing device 130 receives the command from the control device 700 via the wireless communication circuitry 140.

At 950, in response to the command, the processing device 130 provides the individual view in place of (or in addition to) the top-down view. In this manner, the robot 100 may provide the top-down and individual camera views as requested for display remotely from the robot 100.

FIG. 10 shows a flowchart of an example procedure 1000 in which the control device 700 (FIG. 7) requests and displays top-down and individual camera views from the firefighting robot 100.

At 1010, the control device 700 receives a top-down view from the robot 100 via the wireless interface 702 of the control device 700. Further, the control device 700 displays the top-down view on the display screen 710 of the control device 700. In this manner, an operator of the control device 700 may view the top-down view remotely from the robot 100.

At 1020, the control device 700 receives user input via the user-input controls 720 to switch the top-down view to an individual view from one of the cameras 110. For example, the operator may operate a toggle control of the user-input controls 720 to designate a particular view from one of the cameras 110.

At 1030, the control device 700 transmits a command requesting an individual view from one of the cameras 110 of the robot 100. The control device 700 transmits the command via the wireless interface 702.

At 1040, the control device 700 receives the individual view from the robot 100 via the wireless interface 702. Further, the control device 700 displays the individual view in place of the top-down view on the display screen 710.

At 1050, the control device 700 continues to receive additional user input via the user-input controls 720 to switch to an individual view from another one of the cameras 110. Similar procedures may continue as described above.

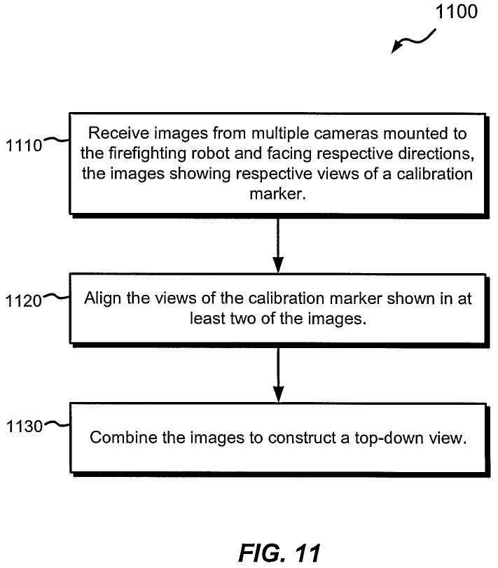

FIG. 11 shows a flowchart of an example procedure 1100 for aligning views from the cameras 110 mounted to respective surfaces of the firefighting robot 100. In an example, the procedure 1100 is performed prior to using the robot 100 in a firefighting scenario.

At 1110, the processing device 130 of the robot 100 receives images from the cameras 110. A calibration marker has been placed in the environment of the robot and marks a position relative to the robot for calibration. In an example, the calibration marker is an approximately 2-foot by 2-foot (61-cm by 61-cm) pad and is placed approximately 10 feet (305 cm) from the robot 100 during calibration. However, any object in the surroundings of the robot 100 may be used as the calibration marker.

The calibration marker should be placed in a location that is visible to at least two adjacent cameras, such as the front camera 110F and the right camera 110R. The calibration marker thus appears in multiple images simultaneously.

At 1120, the processing device 130 aligns views of the calibration marker shown in at least two of the images from the cameras. For example, suppose the calibration marker is placed in a forward-right direction of the robot 100, within the fields of view of the cameras 110F and 110R. In this example, both of the cameras 110F and 110R provide images showing the calibration marker. The processing device 130 may match the position of calibration marker in these images to align the images. The processing device 130 similarly aligns images from the remaining cameras 110.

It should be appreciated that the processing device 130 may align images from the cameras 110 even when the cameras 110 are mounted at different heights, as long as the calibration marker is within the respective fields of view. For example, as shown in FIG. 1, the camera 110F is mounted higher than the camera 110R.

At 1130, the processing device 130 combines the images from the cameras 110 to construct the top-down view. In this manner, the processing device 130 may provide the top-down view for display remotely from the robot 100.

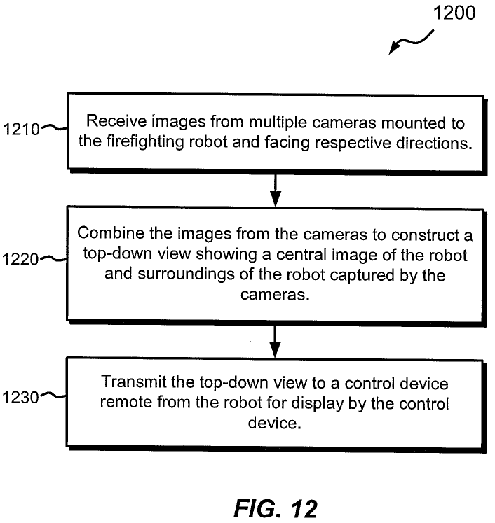

FIG. 12 shows a flowchart of an example procedure 1200 for imaging surroundings of the firefighting robot 100. The method 1200 is typically performed, for example, by the processing device 130 and wireless communication circuitry 140 described in connection with FIG. 1. The various acts of method 1200 may be ordered in any suitable way. Accordingly, embodiments may be constructed in which acts are performed in orders different from that illustrated, which may include performing some acts simultaneously.

At 1210, the processing device 130 of the robot 100 receives images from multiple cameras 110 mounted to the robot 100 and facing respective directions.

At 1220, the processing device 130 combines the images from the cameras 110 to construct a top-down view showing a central image 802 of the robot 100 and surroundings of the robot 100 captured by the cameras 110.

At 1230, the processing device 130 provides the top-down view to the wireless communication circuitry 140, which transmits the top-down view to the control device 700 remote from the robot 100 for display by the control device 700. Advantageously, the top-down view enables the operator of the robot 100 to readily visualize the surroundings of the robot 100, enhancing the operator's ability to operate the robot 100 in a tight quarters and hazardous environments.

An improved technique for visualizing an environment around a firefighting robot includes receiving images from cameras mounted to the firefighting robot and facing respective directions, synthesizing a top-down view of the robot and the immediate surroundings of the robot based on the received images, and displaying the top-down view on a control device in a known orientation.

Having described certain embodiments, numerous alternative embodiments or variations can be made. Further, although features have been shown and described with reference to particular embodiments hereof, such features may be included and hereby are included in any of the disclosed embodiments and their variants. Thus, it is understood that features disclosed in connection with any embodiment are included in any other embodiment. For example, although the procedures 900, 1000, 1100, and 1200 were described above in regards to firefighting robot 100, similar procedures may be used for the other firefighting robots 300 and 500.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as mediums 960 and 1060 in FIGS. 9 and 10). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

Table of Reference Numerals

| Ref. No. | Description |
|---|---|
| 100 | First example firefighting robot. |
| 102 | Body of the firefighting robot 100. |
| 104 | Tracks of the firefighting robot 100. |
| 110 | Cameras mounted to the firefighting robot 100. |
| 110F | Front camera, facing forward to acquire views in front of the |
| | firefighting robot 100. |
| 110B | Back (rear) camera, facing backward to acquire views behind |
| | the firefighting robot 100. |
| 110R | Right side camera, facing right to acquire views to the right |
| | of the firefighting robot 100. |
| 110L | Left camera, facing left to acquire views to the left of the |
| | firefighting robot 100. |
| 120 | Nozzle (monitor), for spraying water, foam, gel, etc., toward |
| | fires. |
| 130 | Processing device, such as an ECU (electronic control unit). |
| 140 | Wireless communication circuitry coupled with the processing |
| | device 130. |
| 300 | Second example firefighting robot. |
| 310 | Cameras mounted to surfaces of the firefighting robot 300. |
| 310F | Front camera, facing forward to acquire views in front of the |
| | firefighting robot 300. |
| 310B | Back (rear) camera, facing backward to acquire views |
| | behind the firefighting robot 300. |
| 310R | Right side camera, facing right to acquire views to the |
| | right of the firefighting robot 300. |
| 310L | Left camera, facing left to acquire views to the left of the |
| | firefighting robot 300. |
| 320 | Brow providing structural protection to the camera 310F. |
| 500 | Third example firefighting robot. |
| 510 | Cameras mounted to surfaces of the firefighting robot 500. |
| 510F | Front camera, facing forward to acquire views in front of the |
| | firefighting robot 500. |
| 510B | Back (rear) camera, facing backward to acquire views behind |
| | the firefighting robot 500. |
| 510R | Right side camera, facing right to acquire views to the right |
| | of the firefighting robot 500. |
| 510L | Left camera, facing left to acquire views to the left of the |
| | firefighting robot 500. |
| 512 | Additional camera mounted at a different height than one or |
| | more of the cameras 510. |
| 520 | Nozzle (monitor), for spraying water, foam, gel, etc., toward |
| | fires. |
| 522 | Camera mounted to the nozzle 520. |
| 700 | Control device for controlling any of the firefighting |
| | robots 100, 300, and 500. |
| 702 | Wireless interface of the remote-control device 700. |
| 710 | Display screen of the remote-control device 700, on which |
| | top-down images and individual camera images from cameras |
| | on robot may be displayed. |
| 720 | User-input controls of the remote-control device 700. |
| 800 | Example screenshot of display screen 710, showing a |
| | top-down view stitched together from the cameras 110 of |
| | the robot 100. |
| 802 | Central image of robot, e.g., displayed in consistent |
| | orientation. |
| 810 | Portion of top-down view showing of objects in front of |
| | robot (and appearing in front of image 802 of robot). |
| 820 | Portion of top-down view showing of objects to the right of |
| | the robot (and appearing to the right of image 802 of robot). |
| 830 | Portion of top-down view showing of objects to the left of the |
| | robot (and appearing to the left of image 802 of robot). |
| 840 | Portion of top-down view showing of objects behind the robot |
| | (and appearing behind the image 802 of robot). |
| 850 | Directional indicator showing a direction in which the nozzle |
| | 120 is aimed. |
| 852 | Directional indicator showing a movement direction of the |
| | nozzle 120. |
| 900 | Method performed by the robot 100, including steps 910, 920, |
| | 930, 940, and 950. |
| 960 | Computer program product storing instructions for performing |
| | method 900, e.g., when executed on processing device 130. |
| 1000 | Method performed by the remote-control device 700, |
| | including steps 1010, 1020, 1030, 1040, and 1050. |
| 1060 | Computer program product storing instructions for performing |
| | method 1000, e.g., when executed by remote-control device |
| | 700. |
| 1100 | Method performed by the robot 100, including steps 1110, |
| | 1120, and 1130. |
| 1200 | Method performed by the robot 100, including steps 1210, |
| | 1220, and 1230. |

What is claimed is:

1. A method of imaging surroundings of a firefighting robot, comprising:
receiving images from multiple cameras mounted to the firefighting robot and facing respective directions;
combining the images from the cameras to construct a top-down view showing a central image of the robot and surroundings of the robot captured by the cameras; and
transmitting the top-down view to a control device remote from the robot for display by the control device.

2. The method of claim 1,
wherein a field of view of a first camera of the cameras partly overlaps with a field of view of a second camera of the cameras, and
wherein combining the images from the cameras includes combining an image from the first camera with an image from the second camera.

3. The method of claim 2,
wherein the image from the first camera and the image from the second camera include respective views of a calibration marker placed in an environment of the robot, and
wherein combining the images from the cameras includes aligning the respective views of the calibration marker.

4. The method of claim 1, wherein combining the images from the cameras includes creating the top-down view as a 360-degree view around the robot.

5. The method of claim 1, wherein combining the images from the cameras includes placing views of the surroundings of the robot relative to the central image of the robot, such that objects in front of the robot appear as images displayed in front of the central image, objects behind the robot appear as images displayed behind the central image, objects to the right of the robot appear as images displayed to the right of the central image, and objects to the left of the robot appear as images displayed to the left of the central image.

6. The method of claim 1, further comprising receiving a command from the control device and transmitting an individual view from one of the cameras in place of the top-down view responsive to the command from the control device.

7. The method of claim 1, wherein combining the images from the cameras includes combining a first image from a first camera mounted at a first height with a second image from a second camera mounted at a second height greater than the first height.

8. The method of claim 1, further comprising:
receiving an image from an additional camera mounted to the robot and facing a common direction as one of the cameras, the additional camera and the one of the cameras being mounted at different heights; and
combining the image from the additional camera with one or more images from the cameras to construct a second top-down view, the top-down view and the second top-down view showing the surroundings of the robot from different perspectives.

9. The method of claim 1, further comprising dynamically adjusting the central image of the robot in the top-down view to reflect a condition of the robot.

10. The method of claim 9, wherein dynamically adjusting the central image includes, responsive to a nozzle of the robot being repositioned to aim in a direction, updating the central image to show the direction in which the nozzle is aimed.

11. The method of claim 10, further comprising, while the nozzle is being repositioned to aim in the direction, updating the top-down view to include a directional indicator that identifies a movement direction of the nozzle.

12. The method of claim 1, further comprising, responsive to the robot being driven, updating the top-down view such that the central image in the top-down view remains stationary as views of the surroundings of the robot change.

13. A firefighting robot, comprising:
a robot body;
multiple cameras mounted to the robot body and facing respective directions relative to the robot body;
control circuitry operatively coupled with the cameras, the control circuitry constructed and arranged to combine images from the cameras to construct a top-down view showing a central image of the robot and surroundings of the robot captured by the cameras; and
wireless communication circuitry constructed and arranged to transmit the top-down view for display remotely from the robot.

14. The firefighting robot of claim 13, wherein the cameras include a front camera that faces in a forward direction relative to the robot, a rear camera that faces in a rearward direction relative to the robot, a left camera that faces in a leftward direction relative to the robot, and a right camera that faces in a rightward direction relative to the robot.

15. The firefighting robot of claim 13, wherein the control circuitry includes an electronic control unit (ECU) of the robot, the ECU constructed and arranged to combine the images from the cameras.

16. The firefighting robot of claim 13,
wherein a field of view of a first camera of the cameras partly overlaps with a field of view of a second camera of the cameras, and
wherein the control circuitry constructed and arranged to combine the images is further constructed and arranged to combine an image from the first camera with an image from the second camera.

17. The firefighting robot of claim 13, wherein the control circuitry is further constructed and arranged to dynamically adjust the central image of the robot in the top-down view to reflect a condition of the robot.

18. The firefighting robot of claim 17, further comprising a nozzle constructed and arranged to aim in multiple directions, wherein the control circuitry constructed and arranged to dynamically adjust the central image is further constructed and arranged to update the central image to indicate a direction in which the nozzle is aimed.

19. A firefighting system, comprising:
a firefighting robot, including:
a robot body;
multiple cameras mounted to the robot body and facing respective directions relative to the robot body;
control circuitry operatively coupled with the cameras, the control circuitry constructed and arranged to combine images from the cameras to construct a top-down view showing a central image of the robot and surroundings of the robot captured by the cameras; and
wireless communication circuitry constructed and arranged to wirelessly transmit the top-down view for display remotely from the robot; and
a remote-control device, including:
a wireless interface constructed and arranged to receive the top-down view from the robot; and
a screen constructed and arranged to display the top-down view.
